(19) United States
(12) Patent Application Publication
(10) Pub. No.: US 2002/0002499 A1
(43) Pub. Date: Jan. 3, 2002

(54) Communication system, output device and information processing device

(76) Inventor: Yoji Furuya, Tokyo (JP)

Correspondence Address: Milbank, Tweed, Hadley & McCloy LLP, 1 Chase Manhattan Plaza, New York, NY, 10005, US

(21) Appl. No.: 09/825,718

(22) Filed: Apr. 4, 2001

(30) Foreign Application Priority Data
Mar. 9, 2001 (JP) 2001-066805
Apr. 4, 2000 (JP) 2000-102169

(51) Int. Cl. G06F 17/60

(52) U.S. Cl. 705/26

(57) ABSTRACT

Data selected by a user side is directly sent to a type of an output device having a predetermined function from a supplier side. Thereby, since the data does not pass through an information processing device on the user side, it can be prevented that the data are varied or obtained dishonestly.

Furthermore, charge information that is generated in response to an output of the data is directly sent to the supplier side from the output device. Thereby, since the charge information does not pass through the information processing device on the user side, variations of the charge information can be prevented.

### BACKGROUND OF THE INVENTION

1. Field of the Invention

The present invention relates to an information processing device and an output device each of which includes a connection function to a communication network such as an internet and so forth on its own and a system including these, and a method for selling data on the system.

2. Related Background Art

Recently, as an internet has spread, data such as a poster, a calendar, a picture and so forth have been sold via an internet. For example, in case that image data are sold via the internet, normally, the data are downloaded to a personal computer to send and print the image data to a printer connected to the personal computer. It was possible to download the image dada to any place of a user (a desktop, an optional folder and so forth).

However, in the conventional method, since the data are downloaded to the personal computer, an illegal copy and illegal variations of the data are easy, and accordingly an undesirable problem exists in terms of a copyright. Furthermore, considering that the data might be copied illegally or varied illegally, a data supplier is forced to add an extra charge in compensation for the risk involved, and as a result, the problem exists that it is impossible to inexpensively supply the data.

### SUMMARY OF THE INVENTION

An object of the present invention is to provide devices and a system and a method that can sell the data safely, inexpensively, and easily in addition to preventing an illegal copy and illegal variations of the data such as a picture and so forth.

Other objects and features of the present invention will become more apparent upon a reading of the following description and drawings.

### BRIEF DESCRIPTION OF THE DRAWINGS

FIG. 1 is a diagram of the principle of a first embodiment.

FIG. 2 is a block diagram of an arrangement of a printer.

FIG. 3 is a flowchart for explaining a process flow on a PC.

FIG. 4 is a flowchart for explaining an operation of an image data reception program.

FIG. 5 is a flowchart for explaining an operation of an image data print program.

FIG. 6 is a flowchart for explaining an operation of a data supplier's Web server.

FIG. 7 is a diagram of the principle of a third embodiment.

FIG. 8 is a conceptual diagram of sales data.

FIG. 9 is a conceptual diagram of product data.

FIG. 10 is a conceptual diagram of output image data.

FIG. 11 is a conceptual diagram of charge data.

FIG. 12 is a block diagram of an arrangement of a data supplier's Web server and a data user's PC.

### DESCRIPTION OF THE PREFERRED EMBODIMENTS

(First Embodiment)

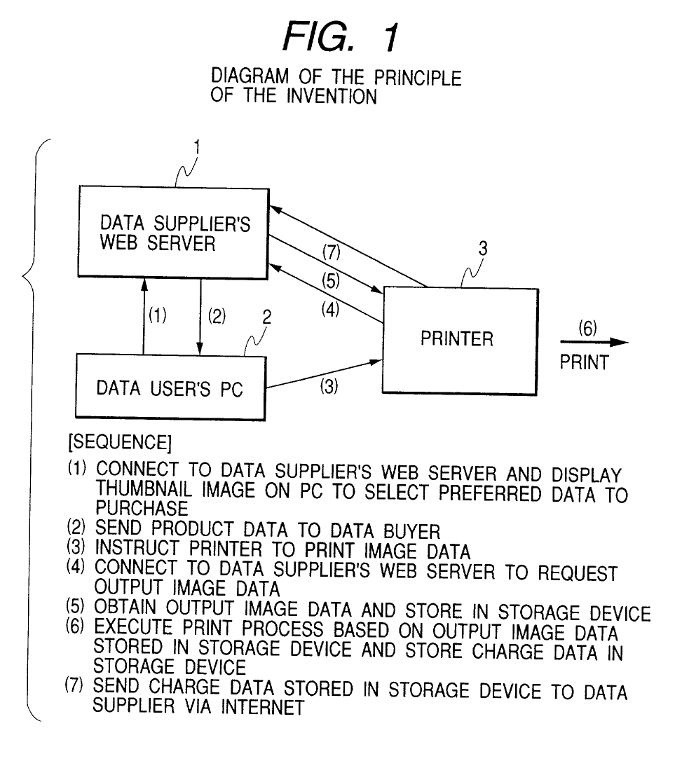

The principle of the present invention will be described in reference to FIG. 1.

In addition, in the present example, the case will be explained as an example in which image data are employed as data, a PC (Personal Computer) as an information processing device, a printer as an output device and an internet as a communication network.

In FIG. 1, 1 is a data supplier's web server, 2 a data user's PC, and 3 a printer connected to the data user's PC. The data user's PC and the printer 3 include an internet connection function on its own respectively.

In (1) of FIG. 1, the data user's PC 2 is connected to the data supplier's Web server 1 via the internet to cause a thumbnail image to be displayed on a display of the PC 2 and to cause the preferred data to be used to be selected.

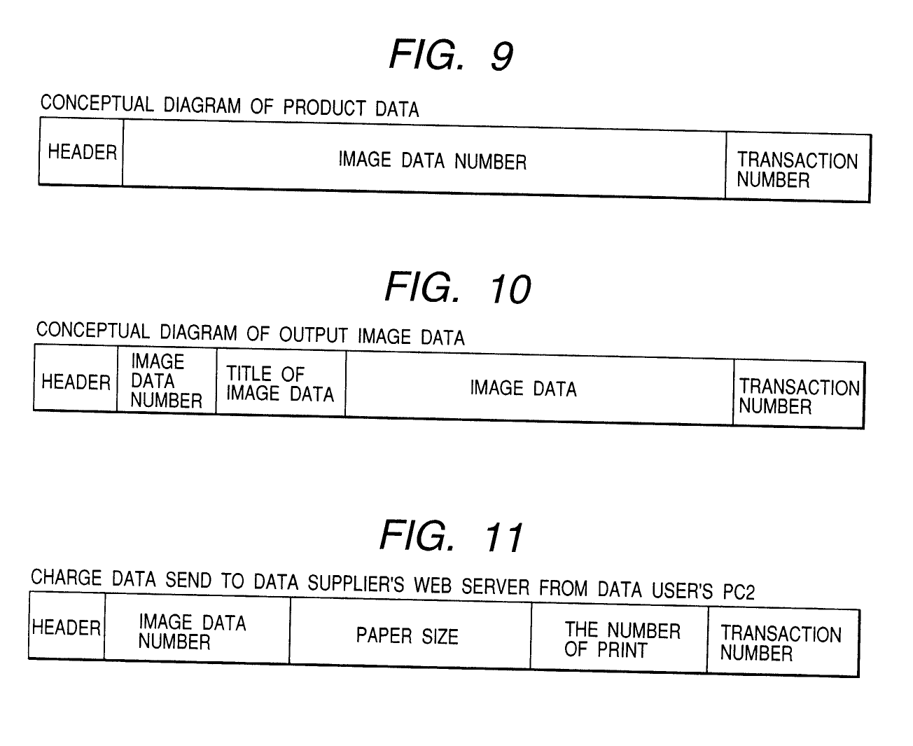

In (2) of FIG. 1, product data shown in FIG. 9 including information necessary for obtaining the image data such as a transaction number for specifying use of the image data, an image data number of the image data selected in (1) and so forth are sent from the data supplier's Web server 1 from the data user's PC 2 via the internet.

In (3) of FIG. 1, the data user notifies the printer 3 of the product data obtained in (2) and a URL (Uniform Resource locator) of the data supplier's Web server 1 and simultaneously instructs the printer 3 to print the image data.

In (4) of FIG. 1, the printer 3 executes the internet connection to the data supplier's Web server based on the URL notified in (3) by the PC 2 to send the product data and requests the selected image data.

In (5) of FIG. 1, the image data are sent from the data supplier's Web server 1 to the printer 3 via the internet.

In (6) of FIG. 1, the printer 3 executes a print process of the received image data and store the charge data based on the print process.

In (7) of FIG. 1, the charge data are sent from the printer 3 to the data supplier's Web server 1 via the internet.

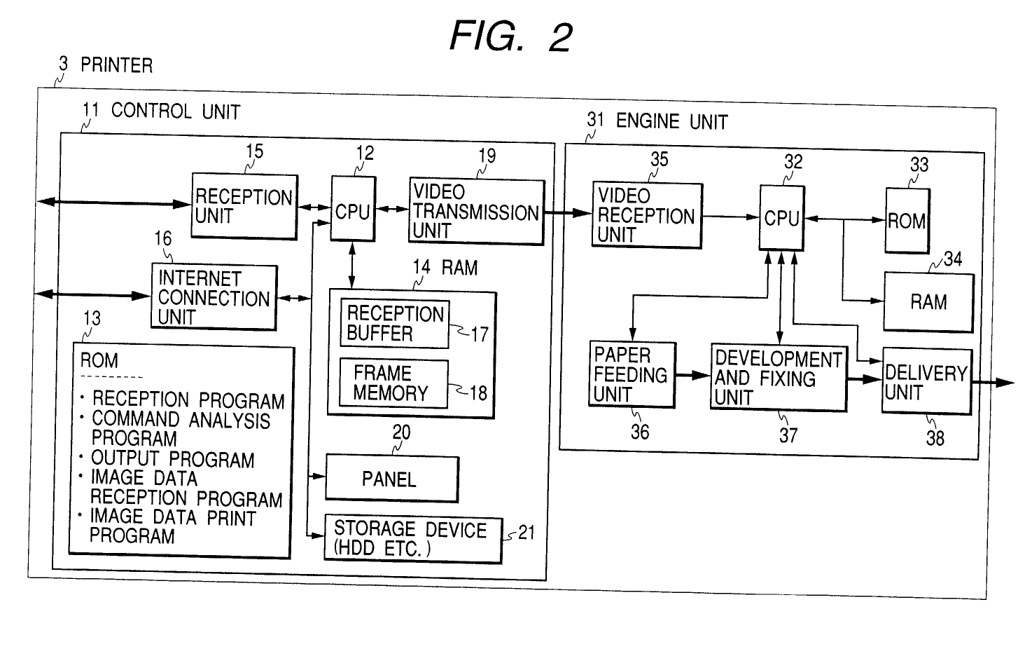

FIG. 2 is a block diagram of an arrangement of the printer 3.

The printer is constructed of a control unit 11 and an engine unit, largely being divided.

The control unit 11 prepares a paper image page by page based on print command data sent from the data user's PC 2 and converts the image into a video signal to send it to the engine unit 31.

The engine unit 31 transcribes and fixes the image onto the paper based on the received video signal to deliver it from the printer 3. In addition, in case of a color printer, as with the video signal, the four video signals with black added to RGB, i.e. red, green and blue are sent. In case of a monochrome printer, the video signal is only one indicating black.

Next, the details of the control unit 11 will be described.

12 is a CPU (Central processing Unit) for controlling the control unit 11 in its entirety.

13 is a ROM (Read Only Memory), and various programs for controlling the control unit 11 are set in the inside thereof.

In the various programs are included a reception program, a command analysis program, an output program, an image data reception program, an image data print program and so forth as main programs, which are executed by the CPU 12.

The reception program plays a role of storing in a reception buffer 17 print command data that are sent from the data user's PC 2 through a reception unit 15.

The command analysis program analyzers the print command stored in the reception buffer 17 to execute a painting work on a frame memory 18.

The output program converts the image on the frame memory 18 into a video signal in video transmission unit 19 to send it to the engine unit 31.

The operation of the image data reception program and the image data print program will be described later.

Furthermore, in the ROM 13, an identifier indicating a model of the printer 3 is stored. 14 is a RAM (Random Access Memory), which has the reception buffer 17, the frame memory 18, a work domain and so forth in the inside thereof.

The frame memory 18 is an image memory domain equivalent to one page of the paper.

In addition, in case of the color printer, the image equivalent to one page of the paper with the four-color information in the form with black added to RGB, i.e. red, green and blue are developed on the frame memory 18. Depending upon a model of the color printer, the frame memory might be divided into four parts for each color.

The work domain is used for work by the reception program, the command analysis program, the output program, the image data reception program, the image data print program and so forth.

16 is an internet connection unit, which is for the image data reception program's executing the internet connection to the data supplier's Web server 1 without passing through the PC 2.

20 is a panel, which is for the data user's operating the printer 3.

A storage device 21 is specifically a HD (Hard Disc) and so forth, which stores the received image data. The image data stored on the HD is impossible to retrieve from the external device that has passed through the network and so forth. In addition, when a predetermined time elapses since storing or a power-off operation is executed at the printer 3, the image data are deleted.

Next, the engine unit 31 will be described.

In the engine unit 31 as well the CPU, the ROM 33 having the control program of the engine unit 31 and the RAM 34 that serves as a work domain of the program are included.

A video reception 35 receives the video signal from the control unit 11 to transcribe the image on the paper in a development and fixing unit 37.

A paper feeding unit 36 takes the paper in from a paper cassette.

The development and fixing unit 37 transcribes and fixes the image on the paper. In case of the color printer, the development and fixing unit 37 respectively transcribes and fixes the paper image by means of the four colors with black added to RGB, i.e. red, green and blue.

A delivery unit 38 delivers the paper that was already printed.

In addition, bold arrows in FIG. 2 indicate flows of the print command data, the data of the page image and the video signal, and in the engine unit 31 indicate flows of the paper. Fine arrows indicate exchange of control among the units.

Even though not shown in the drawing, each of the CPU in the control unit 11 and the CPU 32 in the engine unit 31 also exchanges information with the other. It is information concerning a timing control of the print process such as transcription of the video signal, transfer of the paper and so forth.

When the PC 2 instructs the printer 3 to print the image data, an instruction command for obtaining the image data is stored in the buffer 17 via the reception unit 15 in a similar way to the normal print command data.

The received command is analyzed with the command analysis program and if it is an instruction for obtaining the image data, the image data reception program is started and caused to execute the following processes.

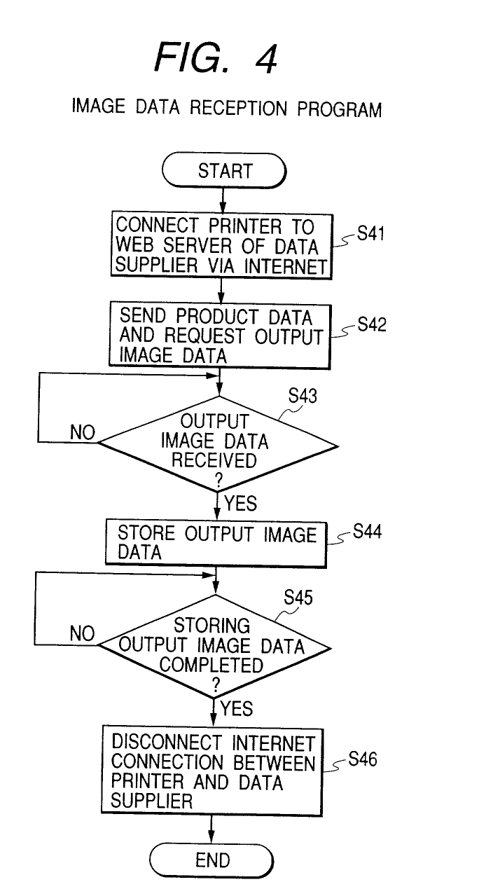

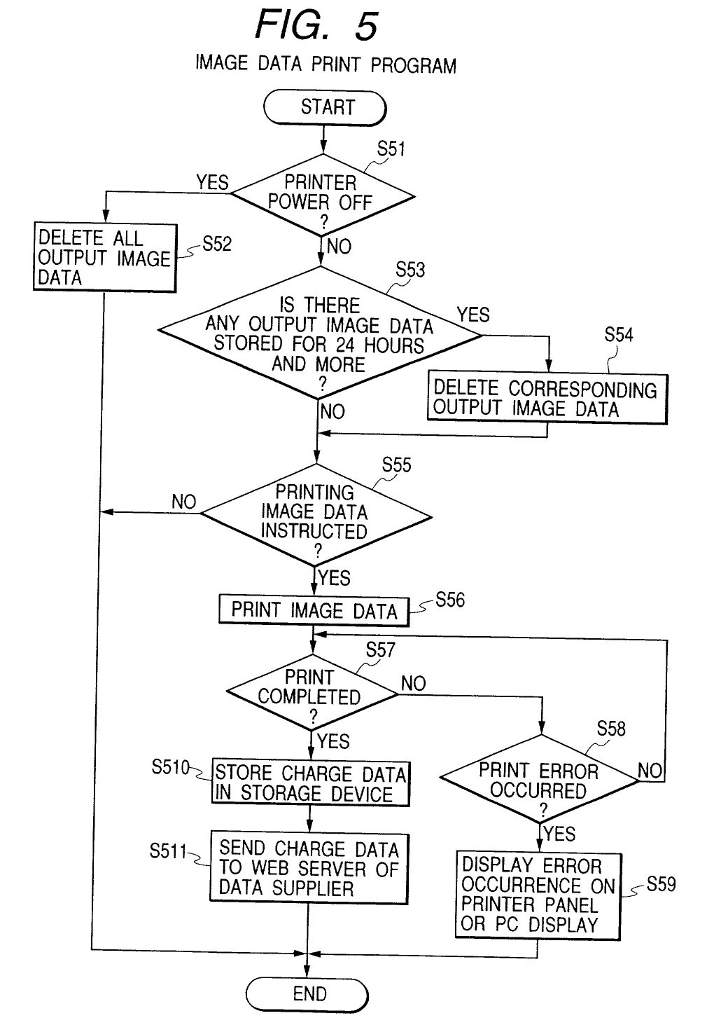

The details of the operation of the image data reception program will be explained in conjunction with the flowchart of FIG. 4 and the details of the operation of the image data print program in conjunction with the flowchart of FIG. 5.

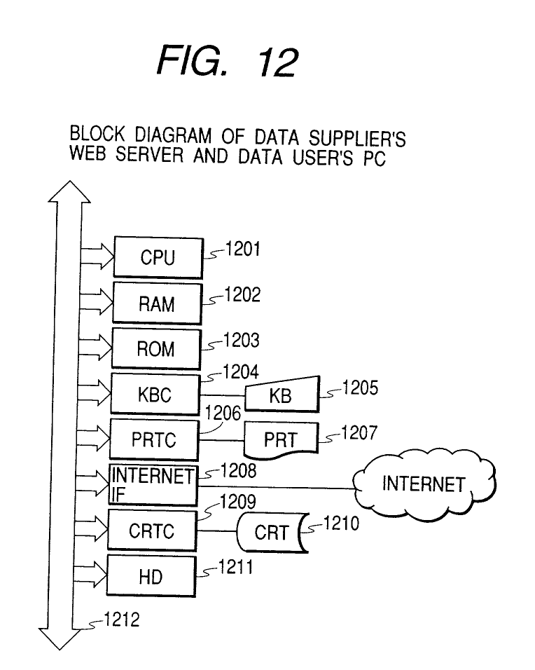

A basic arrangement of the data supplier's Web server 1 and the data user's PC 2 will be explained by use of the block diagram of FIG. 12.

In FIG. 12, 1201 is a CPU, i.e. a Central Processing Unit, which controls the present apparatus on its entirety and executes an arithmetic process. Furthermore, the data supplier's Web server 1 and the data user's PC 2 are operated by the CPU executing a basic I/O program and an OS.

1202 is a RAM, i.e. a Random Access Memory, which is a domain in which each program and each data are loaded and executed on each process.

1203 is a ROM, i.e. a Read Only Memory, which is a memory domain such as a program and so forth for each process.

1204 is a KGC, i.e. a Key Board Controller, which receives the data from a KB, i.e. a Key Board by a key inputting operation to supply them to the CPU. In the PC 2, a KB 1205 or a pointing device (not shown) selects the thumbnail image supplied from the data supplier's Web server 1.

1206 is a PRTC (Printer Controller), which connects to a PRT (Printer) of 1207 to control it. In addition, the PRTC 126 in the PC 2 is forced to connect to the printer 3.

1208 is an INTERNET I/F, which executes the connection to the internet.

1209 is a CRTC (Display Controller), which controls a CRT of 1210. On the CRT 1210 of the PC 2, the thumbnail image supplied from the data supplier's Web server 1 is displayed.

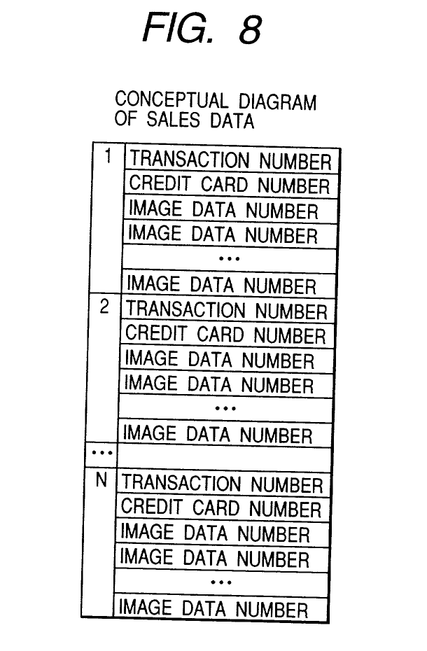

1211 is a storage device such as a HD or a CD-ROM and so forth, which causes the program or the data to be stored and refers thereto or load them to the RAM if necessary. In the HD 1211 of the data supplier's Web server 1, the sales data as shown in FIG. 8 are stored. Moreover, in the HD 1211 of the PC 2, the product data as shown in FIG. 9 are stored.

1212 is a system bus, which is to be a path for data transfer among elements of the arrangement mentioned above.

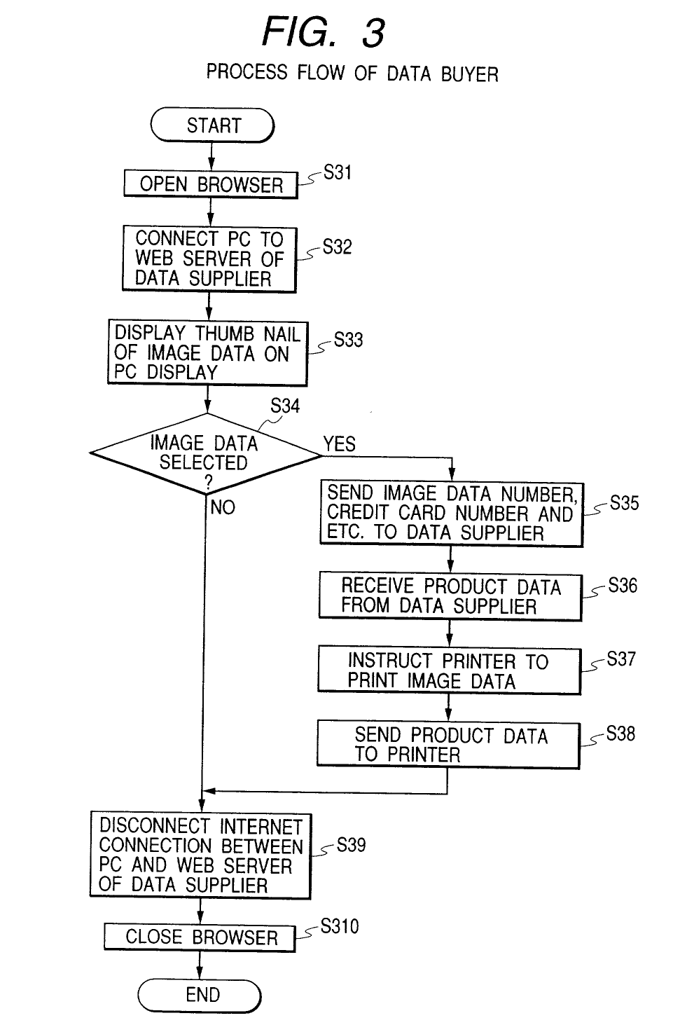

Hereinafter, the operation of the first embodiment will be explained by use of the flowcharts of FIG. 3 to FIG. 6.

FIG. 3 is a flowchart indicating a flow of the process that the CPU 1201 in the data user's PC 2 executes according to the programs stored in the RAM 1202 or the ROM 1203. Each procedure proceeds according to the instruction by the data user.

In a step S31, the data user opens a browser.

In a step S32, the PC 2 and the data supplier's Web server 1 are connected via the internet interface 1208.

In a step S33, the thumbnail image data of the image are displayed on the CRT 1210 in the PC 2.

In a step S34, it is determined if the data user has selected the image data to be purchased from the thumbnail image of the image data displayed on the PC 2. In addition, the image data to be selected might be plural.

In a step S35, information necessary for purchasing the image data such as the image data number of the selected image data, a credit card number and so forth that have been input by the data user is sent to the data supplier's Web server 1.

In a step S36, the data user's PC 2 receives from the data supplier the product data as shown in FIG. 9 including the transaction number, the image data number and so forth to store them in the storage device 1211.

In a step S37, the data user's PC 2 instructs the printer 3 to print the image data via the printer controller 1206.

In a step S38, the product data (FIG. 9) stored in the URL of the data supplier's Web server 1 and the storage device 1211 are sent to the printer via the print controller 1206.

In a step S39, the internet connection between the PC 2 and the data supplier's Web server 1 is disconnected.

In a step S310, the browser is closed to finish the process.

FIG. 4 is the flowchart for explaining the operation of the image data reception program in the printer 3.

The image data reception program is started from the command analysis program, when the PC 2 instructs the printer 3 to print the image data.

In a step S41, the printer 3 connects to the data supplier's Web server 1 via the internet based on the URL of the data supplier's Web server 1 notified from the PC 2.

Herein, in case that the PC 2 and the printer 3 share a circuit for connecting to the internet and that the PC is using the corresponding circuit, the printer 3 requests the PC so as to disconnect the internet connection, and the process of the step S41 is executed after the disconnection has been confirmed. Furthermore, in case that the PC 2 and the printer 3 do not share the circuit, the printer 3 executes the internet connection independent of the internet connection of the PC 2.

In a step S42, the product data (FIG. 9) received from the PC 2 and the identifier indicating the model of the printer 3 stored in the ROM 13 are notified to the data supplier's Web server 1 and simultaneously the data supplier's Web server 1 is requested to send the corresponding image data to the printer 3.

In a step S43, it is determined if the printer 3 has received from the data supplier's Web server 1 the output image data shown in FIG. 10 including the corresponding image data and the image data number, a title of the image data and the transaction number.

If the printer 3 has received the output image data, in a step S44, the output image data (FIG. 10) are stored in the storage device 21 in the printer 3.

In a step S45, it is determined if the storage process has been completed.

If the storage process has been completed, in a step S46, the internet connection between the printer 3 and the data supplier's Web server 1 is disconnected to finish the process of the image data reception program.

FIG. 5 is the flowchart for explaining the operation of the image data print program in the printer 3.

The image data print program is started simultaneously with power-on of the printer 3.

In a step S51, it is determined if the printer 3 has detected the power-off operation.

In case that the power-off operation has been detected, in a step S52, all output image data stored in the storage device 21 and charge data to be described later are deleted to finish the process. Thereby, it can be prevented that the printer 3 is powered off and is disassembled to take the image data out from the storage device 21.

In case that the power-off operation has not been detected, in a step S53, it is determined if the output image data stored for 24 hours and more exist.

If the output image data stored for 24 hours and more exist, in a step S54, the corresponding output data are deleted.

In a step S55, it is determined if printing the image data has been instructed.

If printing the image data has been instructed, in a step S56, the print process of the received output image initiates by executing the operation described in FIG. 4. Herein, the print process is executed by the data user in a print form such as the number of print, a paper size and so forth designated by the PC 2 or the printer 3.

In a step S57, it is determined if the print process has been completed.

In case that the print process has not been completed, in a step S58, it is determined if a printer error has occurred.

In case that the printer error has not occurred, the process returns to the step S57.

In case that the print process has been completed without the print error, in a step S510, the charge data including the transaction number, the image data number, the number of print and so forth are stored in the storage device 21 in a form shown in FIG. 11.

Furthermore, in a step S58, in case that the print error has occurred, in a step S59, printer error occurrence is displayed on the panel 20 or the CRT 1210 of the PC 2 to notify the data user.

In addition, in case that the print error has occurred, the data that became the error is not subject to the charge and the charge data are no stored, because the data has not been normally printed. In case that the error has occurred halfway through the print process of a plural number, the charge data are stored only for those printed normally.

The charge data stored in the storage device 21, in a step S511, are sent from the printer 3 to the data supplier's Web server 1 via the internet in a form including the transaction number, the image data number that has been output, the paper size, the number of print as shown in FIG. 11.

In addition, in the above-mention explanation, the charge data are sent from the PC 2 to the data supplier's Web server 1 at every time when the image data are printed. However, if the image data number of the output image data and the title of the image data stored in the storage device 21 are caused to be displayed on the panel 20 of the printer 3 or on the display of the PC 2, and upon the data user selecting the image data number, the corresponding image data are adapted to be printed, the data user can execute the print repeatedly while the output image data are stored in the storage device 21. In this case, the charge data may be sent in a sizable sum when the conditions is met such as every given time, every given number of the process, every given number of print and so forth. In this case, in the above-mentioned step S52, if there is the charge data of which transmission to the data supplier's Web 1 has not been completed yet, the charge data is deleted after the transmission of the charge data to the data supplier's Web server 1 has been completed.

Furthermore, a method is thought in which the charge data (FIG. 11) are sent just before the output image data are deleted from the storage device 21 after detecting the power-off operation of the printer 3 or after 24 hours have elapsed since storing the output image data.

In addition, in the present embodiment, the explanation was given on the premise that the image data are deleted from the printer 3 after 24 hours since storing, but it is not limited to 24 hours and it is also possible to process at the data supplier's voluntary time.

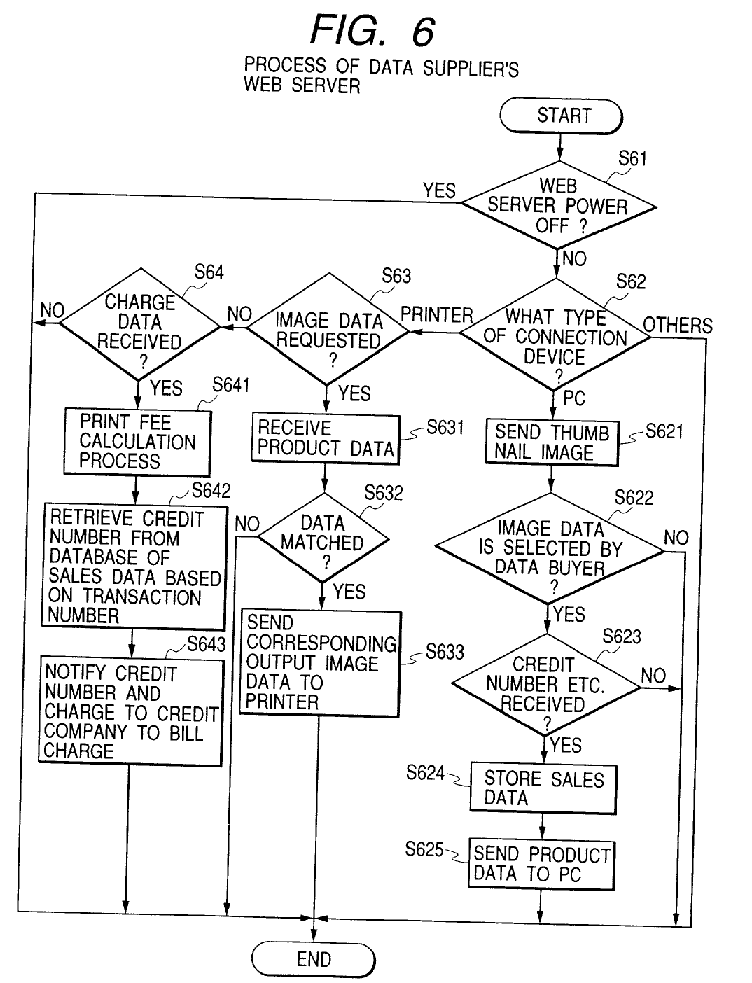

FIG. 6 is the flowchart for explaining the operation of the data supplier's Web server 1. In addition, the operation to be explained hereinafter is executed by the CPU 1201 of the data supplier's Web server 1 according to the program stored in the ROM 1203.

The data supplier's Web server 1 initiates the operation simultaneously with power-on.

In a step S61, it is determined if the data supplier's Web server 1 has detected the power-off operation.

If the power-off operation has been detected, the operation of the data supplier's Web server 1 finishes.

If the power-off operation has not been detected, in a step S62, the device connected to the data supplier's Web server 1 is determined by the identifier indicating the type of the device that is notified from the corresponding device that is connected to the data supplier's Web server 1 via the internet.

In a step S622, if the connected device is determined to be the PC, in a step S621, the thumbnail image of the image data is sent to the PC.

In a step S622, the data user selects the image data by means of the keyboard or the pointing device to determine if information specifying the image data has been sent from the data user's PC 2.

Furthermore, in a step S623, it is determined if information necessary for purchasing the image data such as the credit number and so forth has been received from the data user's PC 2.

If information specifying the image data such as the credit card number and so forth is received from the PC 2, in a step S624, the transaction number is generated, and the corresponding transaction number, the credit card number, the image data number of the selected image data and so forth are caused to be corresponded to store them in the memory 1211 as sales data as shown in FIG. 8.

Herein, since the transaction number and the credit card number have been correspondingly stored in the data supplier's Web server 1, in the following operations only the transaction number may be sent between the data supplier's Web server 1 and the data user's PC 2. Accordingly, the frequency decreases at which the data user sends the credit card number, the possibility lowers that it is retrieved dishonestly halfway through transmission, as a result safety is enhanced and the data user can purchase the data at his/her ease.

In a step S625, the product data (FIG. 9) such as the transaction number, the image data number and so forth are sent to the data user's PC 2.

If, in the step S62, the device is determined to be the model of the printer that can guarantee safety of the image data that are sent from the data supplier's Web server 1 by the identifier that is notified from the corresponding connected device, in a step S63, it is determined if the transmission of the image data has been requested. Specifically, the deletion process of the data such as the step S51 described above is executed or retrieve of the data in the storage device 21 of the printer from the external via the network and so forth is made impossible and thereby, it is determined if the device is the type of the printer having a function of completely preventing the user from illegally obtaining the image data.

In addition, if, in the step S62, the device is determined not to be the type of the printer that can guarantee the safety of the image data that are sent from the Web server 1 by the identifier that is notified from the corresponding connected device, the effect that the image data is impossible to send is sent to the corresponding device to finish the process.

If, in the step S63, it is determined that the transmission of the image data has been requested, in a step S631, the product data (FIG. 9) are requested of the printer 3 and are received.

In a step S632, it is confirmed if the transaction number and the image data number in the received product data match the transaction number and the image data number in the sales data stored in the storage device 1211.

If the data match, in a step S633, the output image data including the corresponding image data and so forth are sent to the printer 3.

In the step S63, if it is determined that the image data has not been requested, in a step S64, it is determined if the charge data has been received.

If the charge data has been received, a fee calculation process is executed based on the received charge data.

In a step S642, the credit card number that is caused to correspond to the transaction number attached to the charge data is retrieved from the sales data stored in the storage device 1211.

In a step S643, the credit card number and the charge calculated in the step S641 are notified to a credit company to execute a charge bill process.

In accordance with the first embodiment as mentioned above, it allows the printer itself to receive and store the image data and to store and send the charge data that the printer includes a function of the internet connection. Moreover, since the printer can connect to the internet without passing through the PC and the image data and the charge data do not pass through the data user's PC, it is possible to prevent a dishonest act such as the illegal copy of and variations of the data in the PC and so forth.

As mentioned above, the dishonest act to the image data and the charge data can be prevented, therefore, the cost against the risk involved can be reduced, and the image data can be sold on the internet safely, inexpensively and easily.

In the embodiment of the present invention, the output image is explained as the image data, but in addition thereto moving image data, static image data, voice data, document data, game soft data and so forth may be applied.

Furthermore, the output device as well is explained as the printer, but a monitor, a stereo, a game player and so forth may be applied.

In addition, the case is exemplified in which the internet is employed as the communication network, but the case could be thought in which the other computer networks such as a LAN, a VAN, a WAN and so forth are employed.

Moreover, as with the charge bill process the case is exemplified and explained in which the credit company is used, but it is possible to use the other electronic methods of payment settlement.

(Second Embodiment)

In the first embodiment, the printer 3 stored the received image data and charge data in the storage device 21 as they were.

In the present embodiment, a storage unit and a decode unit are kept in the control unit 11 of the printer 3, and the image data and the charge data are stored after coding.

This allows the safety of the image data and the charge data to be further enhanced. Furthermore, in this time, if the transaction number is used as one part of a coding parameter, the safety is furthermore enhanced.

(Third Embodiment)

In the first embodiment, only by the identifier that is sent from the device is executed determination if the corresponding device connected to the data supplier's Web server 1 is the type of the printer that can guarantee the safety of the image data that are sent from the PC or the Web server 1. Therefore, in the present embodiment, the case will be explained in which by furthermore causing the printer to make a maintenance contract, which is managed by the data supplier, and by determining according to registered information, the data supplier can send the image data more safely.

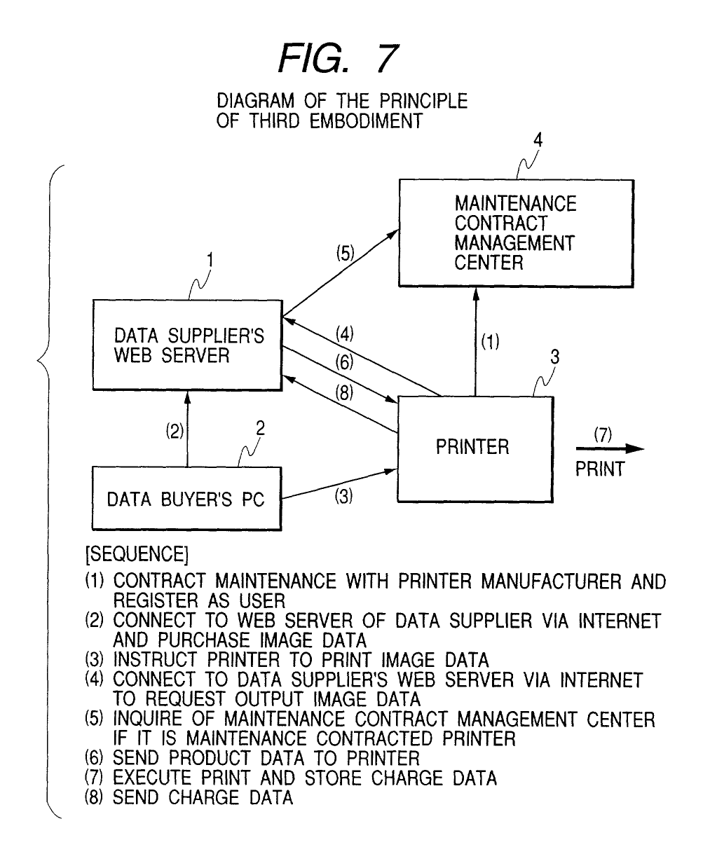

FIG. 7 is the diagram of the principle.

When the printer 3 makes the maintenance contract, information such as a serial number, a location site, a user's name and so forth thereof are registered in a maintenance contract management center's server 4.

When the printer 3 requests the transmission of the image data, it sends to the data supplier's Web server 1 the serial number of the printer 3 in addition to the number of the image data to be purchased, the transaction number and so forth.

The data supplier's Web server 1 inquires of a maintenance contract management center's server 4 to determine if it is the maintenance-contracted printer 3 based on the serial number of the printer 3.

If it is the maintenance-contracted printer 3, the data supplier's Web server 1 sends the image data to the printer 3.

If it is the maintenance-not-contracted printer 3, the data supplier's Web server 1 rejects the transmission of the image data and stops the transmission of the image data.

In addition, the maintenance contract management center's server 4 may be located either within or outside the data supplier's Web server 1.

(Fourth Embodiment)

In the first embodiment, when the print process of the image data was executed, the data user designated the number of print, the paper size and so forth at the PC 2 or the printer 3. However, the case is thought in which the data user wants to output the image data supplied by the data supplier in a desired form.

In this case, in the above-mentioned step S633 of FIG. 6, the output image data to which print form designation information indicating the number of print and the paper size has been attached are sent from the data supplier's Web server 1 to the printer 3.

And, the printer 3 executes the print output based on the received print form designation information in the step S56 of FIG. 5.

This allows the data output to be executed in the print form designated by the data supplier.

As explained above, in accordance with the present information, by causing the output device to have the connection function to the communication network, the output data from the data supplier's information processing device can be directly sent to the output device without passing through the data user's information processing device, and thereby, the dishonest act such as an illegal copy and variations of the data and so forth can be prevented. Furthermore, the charge data as well based on the data output can be directly sent to the data supplier's information processing device from the output device without passing through the data user's information processing device, and thereby, variations of the charge data can also be prevented.

Furthermore, the image data is adapted to be sent only to the type of the output device having a specific function, therefore, the data supplier does not need to be worried about variations and dishonest acquisition of the image data.

Accordingly, an advantage can be effected: the data supplier can reduce the cost against the risk accompanied by the transmission of the data and can sell the data safely, inexpensively and easily.

What is claimed is:

1. A communication system capable of outputting data selected by an information processing device on a user side from data to be supplied to an information processing device on a supplier side, comprising:
an output device including data request means for requesting the information processing device on the supplier side to send the data selected by said information processing device on the user side; and
an information processing device on a supplier side including:
determination means for determining a type of the output device in which the request is made by said request means; and
a controller for controlling the transmission of the data to said output device in response to the determination by said determination means;
wherein said output device communicates with said information processing device on the supplier side by connection independent of said information processing device on the user side.

2. The communication system according to claim 1, wherein said output device includes transmission means for sending, to said information processing device on the supplier, charge information in response to an output of the data selected by said information processing device on the user side.

3. The communication system according to claim 2, wherein said output device including;
charge information storage means for storing said charge information; and
deletion means for deleting said charge information from said charge information storage means after having sent said charge information to said information processing device on the supplier side in case that a power-off operation of said output device has been detected.

4. The communication system according to claim 1, wherein said output device including;
data storage means for storing the data received from said information processing device on the supplier side that said formation processing device on the user side has selected;
deletion means for deleting said data from said data storage means in case that the data has been stored in said storage means for a predetermined time, or in case that the power-off operation of said output device has been detected.

5. The communication system according to claim 1, wherein said determination means determines if said output device is a type of the output device having a predetermined function.

6. The communication system according to claim 1, further comprising:
an information processing device on a manager side including management means for registering and managing said output device;
wherein said determination means determines if said output device has been registered by said management means.

7. The communication system according to claim 6, wherein said information processing device on the manager side is included in said information processing device on the supplier side.

8. The communication system according to claim 1, wherein said determination means determines the type of the device connected to said information processing device on the supplier side, and said controller sends information for causing the data to supplied to be selected if it is determined that said connected device is the information processing device and sends to said output device the data designated by said information processing device on the user side if it is determined that said connected device is the type of the output device having a predetermined function.

9. An information processing device on a supplier side that supplies the data, comprising:
determination means for determining the type of the device that requests the transmission of the data selected by the information processing device on the user side on based on product data including information on the data selected by the information processing device on the user side; and
a controller for controlling the transmission of the data to said output device in response to the determination by said determination means;
wherein said output device communicates with said information processing device on the supplier side by the connection independent of said information processing device on the user side.

10. The information processing device on the supplier side according to claim 9, wherein said determination means determines the type of the device connected to said information processing device on the supplier side, and said controller sends information for causing the data to be supplied to be selected if it is determined that said connected device is the information processing device and sends to said output device the data designated by said information processing device on the user side if it is determined that said connected device is the type of the output device having a predetermined function.

11. An output device capable of communicating with an information processing device on a supplier side that supplies data and an information processing device on a user side that selects said supplied data, comprising:
reception means for receiving product data including information on the data selected by said information processing device on the user side;
connection means for connecting to said information processing device on the supplier side independent of said information processing device on the user side;
data request means for notifying an identifier indicating the type of said output device via the connection by said connection means and for simultaneously requesting said information processing device on the supplier side to send the data based on said received product data; and
output means for outputting the data sent from said information processing device on the supplier side in response to a result of having determined said identifier notified from said data request means.

12. The output device according to claim 11, further comprising:
charge information transmission means for sending to said information processing device on the supplier side the charge information that has responded to the output of the data by said output means via the connection by said connection means.

13. The output device according to claim 10, further comprising:
charge information storage means for storing said charge information; and
deletion means for deleting said charge information from said charge information storage means after said transmission has been executed by said charge information storage means, in case that the power-off operation has been detected.

14. The output device according to claim 11, further comprising:
data storage means for storing the data received from said information processing device on the supplier side; and
deletion means for deleting said data from said data storage means in case that the data has been stored in said storage means for a predetermined time, or in case that the power-off operation of said output device has been detected.

15. A communication system including an information processing device on a supplier side that supplies data, an information processing device on a user side capable of selecting said data to be supplied and an output device capable of outputting said selected data, comprising:
an information processing device on a user side including instruction means for instructing said output device to output the data selected from the data that said information processing device on the supplier side supplies;
connection means for connecting to said information processing device on the supplier side independent of said information processing device on the user side;
reception means for receiving the data instructed by said instruction means from said information processing device on the supplier side via the connection by said connection means; and
transmission means for sending to said information processing device on the supplier side charge via the connection by said connection means information that responded to the output of the data received from said reception means.

16. The communication system according to claim 15, wherein said output device includes:
charge information storage means for storing said charge information; and
deletion means for deleting said charge information from said charge information storage means after said charge information has been sent to said information processing device on the supplier side, in case that the power-off operation has been detected.

17. The communication system according to claim 15, wherein said output device includes:
data storage means for storing the data received from said information processing device on the supplier side that said information processing device on the user side has selected; and
deletion means for deleting said data from said data storage means in case that the data has been stored in said storage means for a predetermined time, or in case that the power-off operation of said output device has been detected.

18. The communication system according to claim 15, wherein the information processing device on the supplier side includes:
determination means for determining the connected device; and
a controller for controlling so as to send information for causing the data to be supplied to be selected if it is determined by said determination means that the connected device is the information processing device and to send to said output device the data selected by said information processing device on the user side if it is determined that said device is the output device.

19. The communication system according to claim 18, wherein said determination means determines if said device is the type of the output device having a predetermined function, in case that said device is the output device.

20. The communication system according to claim 15, further comprising:
an information processing device on a manager side including management means for registering and managing said output device; wherein said information processing device on the supplier side includes:
determination means for determining the connected device;
a controller for controlling so as to send the data for causing the data to be supplied to be selected if it is determined by said determination means that the device connected to said information processing device on the supplier side is the information processing device and to send to said output device the data selected by said device on the user side if it is determined that said device is the device registered by said management means.

21. The communication system according to claim 20, wherein said information processing device on the manager side is included in said information processing device on the supplier side.

22. An output device capable of communicating with an information processing device on a supplier side that supplies data and an information processing device on a user side that selects said supplied data, comprising:
connection means for connecting to said information processing device on the supplier side independent of said information processing device on the user side;
reception means for receiving the data selected by said information processing device on the user side from said information processing device on the supplier side via the connection by said connection means; and
transmission means for sending to said information processing device on the supplier side the charge information that has responded to the output of the data received from said reception means.

23. The output device according to claim 22, further comprising:
charge information storage means for storing said charge information; and
deletion means for deleting said charge information from said charge information storage means after said transmission has been executed by said charge information transmission means, in case that the power-off operation of said output device has been detected.

24. The output device according to claim 22, further comprising:
data storage means for storing the data received from said information processing device on the supplier side; and
deletion means for deleting said data from said data storage means in case that the data has been stored in said data storage means for a predetermined time, or in case that the power-off operation of said output device has been detected.

25. A control method for controlling an information processing device on a supplier side that supplies data, comprising:
a determination step for determining a type of a output device requesting the transmission of the data selected by said information processing device on the user side based on the product data including information on the data selected by said information processing device on the user side; and
a control step for controlling the transmission of the data to said output device in response to the determination in said determination step;
wherein said output device communicates with said information processing device on the supplier side by the connection independent of said information processing device on the user side.

26. A control method for controlling a output device capable of communicating with an information processing device on a supplier side that supplies data and an information processing device on a user side that selects said supplied data, comprising:
a reception step for receiving the product data including information on the data selected by said information processing device on the user side;
a connection step for connecting to said information processing device on the supplier side independent of said information processing device on the user side;
a data request step for notifying the identifier indicating the type of said output device via the connection in said connection step and for simultaneously requesting said information processing device on the supplier side to send the data based on said received product data; and an output step for outputting the data sent from said information processing device on the supplier side in response to a result of having determined said identifier notified in said data request step.

27. A control method for controlling a output device capable of communicating with an information processing device on a supplier side that supplies data and an information processing device on a user side that selects said supplied data, comprising:
a connection step for connecting to said information processing device on the supplier side independent of said information processing device on the user side;
a reception step for receiving the data selected by said device on the user side from said information processing device on the supplier side via the connection in said connection step; and
a transmission step for sending to said information processing device on the supplier side a charge information that has responded to the output of the data received in said reception step.

28. A storage medium that has stored a program for controlling the information processing device on the supplier side that supplies data, said program comprising:
a determination step for determining the type of the output device requesting the transmission of the data selected by said information processing device on the user side based on the product data including information on the data selected by said information processing device on the user side; and
a control step for controlling the transmission of the data to said output device in response to the determination in said determination step;
wherein said output device communicates with said information processing device on the supplier side by the connection independent of said information processing device on the user side.

29. A storage medium that has stored a program for controlling the output device capable of communicating with the information processing device on the supplier side that supplies the data and the information processing device on the user side that selects said supplied data, said program comprising:
a reception step for receiving the product data including information on the data selected by said information processing device on the user side from said information processing device on the user side;
a connection step for connecting to said information processing device on the supplier side independent of said information processing device on the user side;
a data request step for notifying the identifier indicating the type of said output device via the connection in said connection step and for simultaneously requesting said information processing device on the supplier side to send the data based on said received product data; and
an output step for outputting the data sent from said information processing device on the supplier side in response to a result of having determined said identifier notified in said data request step.

30. A storage medium that has stored a program for controlling the output device capable of communicating with the information processing device on the supplier side that supplies the data and the information processing device on the user side that selects said supplied data, said program comprising:
a connection step for connecting to said information processing device on the supplier side independent of said information processing device on the user side;
a reception step for receiving the data selected by said information processing device on the user side from said information processing device on the user side via the connection in the said connection step;
transmission means for sending to said information processing device on the supplier side the charge information that has responded to the output of the data received from said reception means via the connection in said connection step.
